(19) United States
(12) Patent Application Publication
(10) Pub. No.: US 2013/0069745 A1
(43) Pub. Date: Mar. 21, 2013

(54) ELECTROMAGNET

(71) Applicant: Patrik Fuchs, Kirkel (DE)

(72) Inventor: Patrik Fuchs, Kirkel (DE)

(21) Appl. No.: 13/261,484

(22) PCT Filed: Mar. 23, 2011
(86) PCT No.: PCT/EP11/01428

§ 371 Date: Oct. 22, 2012

(30) Foreign Application Priority Data
May 21, 2010 (DE) 10 2010 021 175.3

(51) Int. Cl. H01F 7/16; H01F 7/08

(52) U.S. Cl. 335/262

(57) ABSTRACT

The invention relates to an electromagnet, in particular a switching magnet, having a field winding (11) which is located on a coil former (7), and having a pole piece (23) which forms a part of the magnetic return path, wherein a pole core (17) and an axially movable magnet piston (19) are provided within the coil former (7), the pole piece (23) forms an aperture opening (25) for the magnet piston (19) on the area opposite the pole core (17), and said magnet piston (19) is borne for its movement in its guide in the pole core (17), characterized in that the pole piece (23) has a flange part (27) which at least partially engages over the coil former (7) at its axial end, and has a bush part (29) which extends axially therefrom and, within the coil former (7), forms a hollow cylinder which engages over a longitudinal section of the magnet piston (19) between the inner wall of which hollow cylinder and the circumference of the magnet piston (19) a parasitic air gap (30) is formed.

The invention relates to an electromagnet, in particular a switching magnet, having a field winding, which is located on a coil form, and a pole piece, which forms a part of the magnetic return path, wherein a pole core and an axially movable magnetic piston are provided inside the coil form; the pole piece forms an aperture opening for the magnetic piston on the region opposite the pole core; and said magnetic piston is mounted in a guide of the pole core in order to move said magnetic piston.

An electromagnet of this kind is known from document EP 1 818 951 B1. The magnetic return path between the pole piece and the magnetic piston are of considerable importance for the operating properties of such magnets. The property of this return path depends on the configuration of the air gap located between the magnetic piston and the pole piece. Generally, a small air gap between the magnetic piston and the pole piece results in an increase in the magnetic force over stroke. The aforementioned document discloses a number of solutions for the geometric design of the air gap that are based on measures for shaping the magnetic piston on its end adjacent to the aperture opening on the pole piece. These solutions involve tapered surfaces at the end section of the piston or a shortening of the length of the piston in such a way that its end surface does not totally extend through the aperture opening.

In the known solutions from the prior art, the operating behavior leaves much to be desired. Working on the basis of the aforesaid, the object of the present invention is to provide an electromagnet that is distinguished by a comparatively improved magnetic force/stroke characteristic.

The invention achieves this object with an electromagnet having the features specified in claim 1 in its entirety.

Accordingly, an essential feature of the invention lies in the fact that a parasitic air gap that is the determining factor for the operating properties of the electromagnet is formed in such a way that the pole piece, connected to a flange part, which partially extends over the axial end of the coil form, forms a bushing part, which extends into the coil form in the form of a hollow cylinder and extends over a longitudinal section of the magnetic piston, so that a parasitic air gap is formed between the inner wall of the hollow cylinder and the circumference of the piston. The difference between the inside diameter of the hollow cylinder of the bushing part and the outside diameter of the piston is chosen in such a way that the gap width can be adjusted to an optimal value. In contrast to the solutions disclosed in the state of the art, there is no change whatsoever in the gap geometry when the piston moves, so that the objective of an optimal force/stroke characteristic can be met.

In especially advantageous exemplary embodiments, the magnetic piston is mounted with a sliding fit on a guide sleeve having a coaxiality relative to the hollow cylinder of the pole piece that has such a tight tolerance that the magnetic piston is not brought into contact with the hollow cylinder when the width of the parasitic air gap is less than 0.1 mm. Friction due to the contact made between the magnetic piston and the pole piece would result in an increase in the hysteresis in the magnetic force/stroke characteristic; and, hence, such contact must be avoided under all circumstances. Since the invention provides a tightly toleranced coaxiality of the guide in the pole core and the guide sleeve, there is the possibility of minimizing the width of the parasitic air gap without having to accept the risk of contact.

In an especially advantageous embodiment, the arrangement can be configured in such a way that a second pole piece, which is designed as the identical part of the first pole piece, is disposed on the region opposite the aperture opening; and said second pole piece forms with its bushing part the tight fit for the pole core mounted in the hollow cylinder. The use of two pole pieces that are identical in construction offers the possibility of reducing the unit price by twice the number of items, so that the end product can be manufactured in an efficient and economical way.

With respect to the design of the rest of the magnetic return path, the arrangement can be configured in such an advantageous way that a magnetic return casing, which at least partially surrounds the winding, forms a magnetic return path to the flange part of the pertinent pole piece. Such exemplary embodiments are distinguished by a high magnetic force compared to the small size.

An especially efficient and economical production is made possible by exemplary embodiments, wherein in order to form a tight unit, the coil form, the pole piece, and the return casing are encapsulated by injection molding with a plastic encapsulating compound that forms a uniform housing.

The invention is explained in detail below by means of one exemplary embodiment depicted in the drawings. Referring to the drawings:

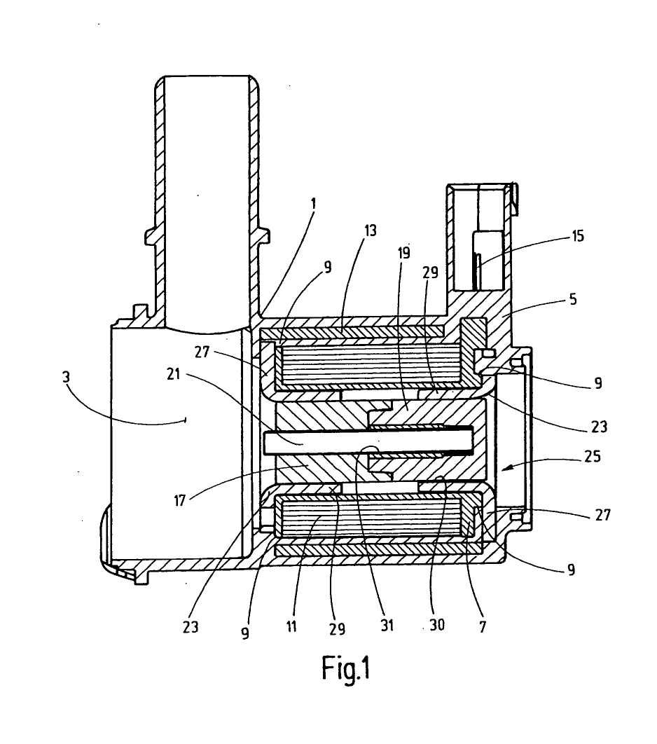

FIG. 1 is a longitudinal sectional view of the exemplary embodiment, wherein a valve device, which may be found in the housing and can be actuated by means of an actuating plunger of the electromagnet, has been omitted for the sake of a better overview.

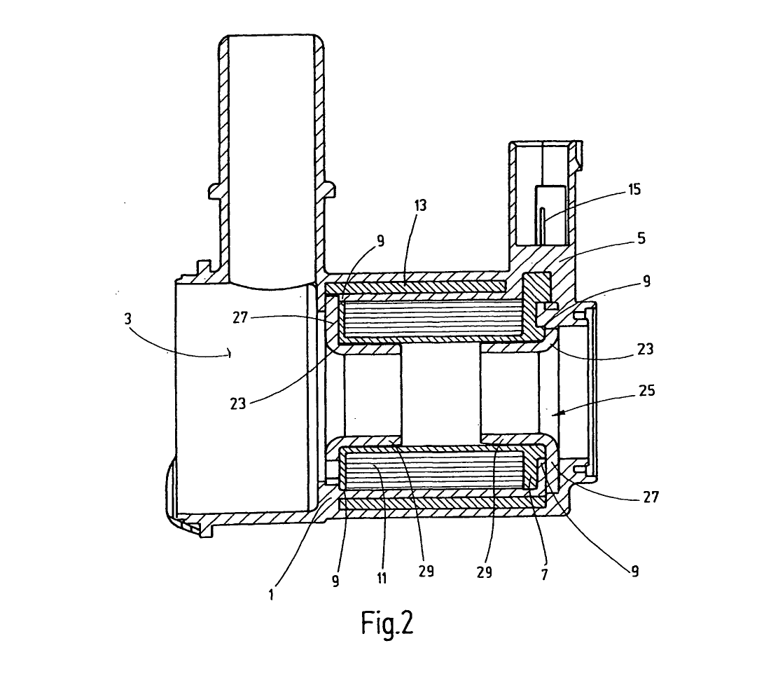

FIG. 2 is a sectional view analogous to the one from FIG. 1, showing the state of the production of the housing by the process of encapsulating the coil form by injection molding, but prior to the incorporation of the pole core and the magnetic piston.

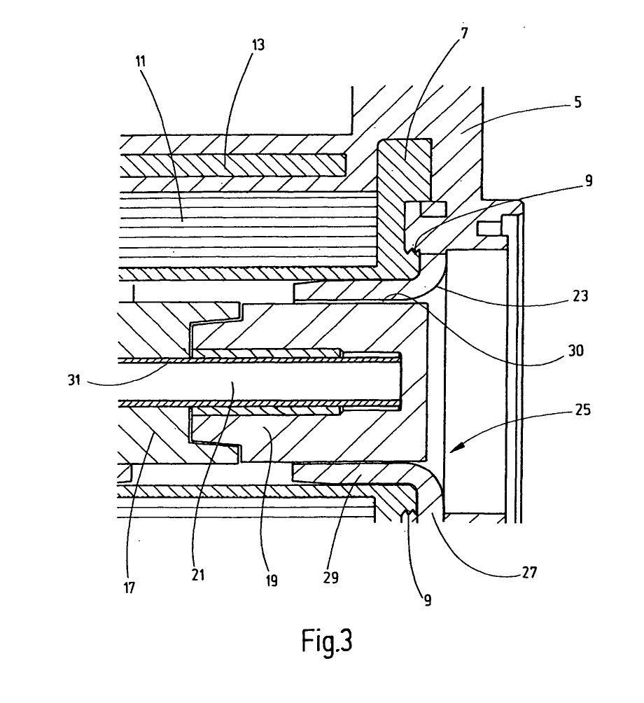

FIG. 3 shows an enlarged detail of the region adjacent to the magnetic piston from FIG. 1.

The invention is explained below by means of one example, where the electromagnet inside a housing 1 forms the actuating element for a valve device, which is arranged in a valve chamber 3 in the housing 1. This valve device has been omitted in the drawing because it is not a part of the invention. The housing 1 is formed as an integral component made of a plastic encapsulating compound 5, with which the coil form 7 and the other components of the electromagnet are encapsulated by injection molding.

In order to guarantee a gas tight connection between the encapsulating compound and the coil form during the process of encapsulation by injection molding, the coil form 7 is provided, as shown more clearly in the enlarged drawing in FIG. 3, with serrations 9 that form the so-called fused edges during the process of encapsulation by injection molding. The field winding 11, which may be found on the coil form 7, is surrounded by a return casing 13, forming a part of the magnetic return path, in the conventional manner for such electromagnets. This return casing is embedded, just like the flat plugs 15, used to supply the winding 11 with current, in the encapsulating compound 5.

On the region facing the valve chamber 3, there is a rigidly mounted pole core 17 inside the coil form 7; and a magnetic piston 19 is arranged so that it can be moved axially relative to said pole core in the interior of the coil form 7. In the drawings from FIGS. 1 and 3, the magnetic piston 19 is shown in the position of its stroke end brought closer to the pole core 17. At this stroke end, a guide sleeve 21, which interacts with the magnetic piston 19 and which can accommodate an actuating plunger (not shown in detail), which is provided for the control of the valve device (not illustrated), may be found in its position located the furthest to the left in the drawing. If it involves a so-called “pushing” electromagnet, then this position of the piston corresponds to the totally energized state of the field winding 11; otherwise, the magnetic piston 19 can be moved to the right from the illustrated end position by supplying current.

For the continuation of the magnetic return path from the return casing 13 into the interior of the coil form 7, there are pole pieces 23, which are constructed as identical parts. Of these pole pieces, a first pole piece 23 forms an aperture opening 25 in the region of the magnetic piston 19; and the magnetic piston 19 can be moved inside this aperture opening. Each of the pole pieces 23 has a flange part 27, which extends over the facing axial end of the coil form 7 in such a way that it extends as far as into the vicinity of the return casing 13. A bushing part 29 extends from the flange part 27 into the interior of the coil form 7. The bushing part 29 forms a hollow cylinder, which extends over a longitudinal section of the piston 19 at the first pole piece 23 and over a longitudinal section of the pole core 17 at the second pole piece 23. In this longitudinal section of the second pole piece 23, the pole core 17 is secured in place by means of a tight fit. The inner wall of the hollow cylinder at the first pole piece 23 may be found at a distance from the circumference of the magnetic piston 19, but in a small parasitic air gap 30, so that the gap width is less than 0.1 mm. In the present exemplary embodiment, the difference between the outside diameter of the magnetic piston 19 and the inside diameter of the hollow cylinder of the bushing part 29 is, for example, 0.07 mm.

A gap width that is minimized in this way without incurring, as a result, the risk of being brought into contact with the magnetic piston 19, a feature that would result in a higher hysteresis and, thus, a malfunction, can be implemented in the present invention in a reliable way by mounting the magnetic piston 19 together with its guide sleeve 21 in a displaceable manner on the pole core 17 with a sliding fit that is subject to tight tolerances and by maintaining a tightly toleranced coaxiality of the hollow cylinder of both bushing parts 29 of the pole pieces 23. This goal is achieved by using a calibrated encapsulating mandrel (not illustrated) in the interior of the coil form 7 that is still open in FIG. 2 during the encapsulation process, in the course of which the production stage depicted in FIG. 2 is reached. The result is that the coaxiality between the hollow cylinders of the bushing parts 29 of both pole pieces 23 can be kept smaller than 0.07 mm. In this way, a totally pressure tight arrangement for the magnet as a whole is also obtained. Furthermore, FIGS. 1 and 3 also show that a cylindrical guide bushing is also used between the outer circumference of the guide sleeve 21 and the facing inner circumference of the magnetic piston 19. However, this guide bushing does not continue, as shown, completely as far as the bottom of the magnetic piston 19. Furthermore, the guide bushing is held in the magnetic piston 19 by means of a shoulder-like diminution of the diameter that passes over, when seen in the direction of the figures to the right, into the bottom of the magnetic piston 19, on which the guide sleeve 21 is supported.

1. An electromagnet, in particular a switching magnet, having a field winding (11), which is located on a coil form (7), and a pole piece (23), which forms a part of the magnetic return path, wherein a pole core (17) and an axially movable magnetic piston (19) are provided inside the coil form (7); the pole piece (23) forms an aperture opening (25) for the magnetic piston (19) on the region opposite the pole core (17), and said magnetic piston is mounted in a guide of the pole core (17) in order to move said magnetic piston, characterized in that the pole piece (23) has a flange part (27), which at least partially extends over the coil form (7) at its axial end, and has a bushing part (29), which extends axially from said flange part and forms a hollow cylinder, which extends over a longitudinal section of the magnetic piston (19), inside the coil form (7); and between the inner wall of the hollow cylinder and the circumference of the magnetic piston (19) a parasitic air gap (30) is formed.

2. The electromagnet according to claim 1, characterized in that the magnetic piston (19) is mounted with a sliding fit on a guide sleeve (21) having a coaxiality relative to the hollow cylinder of the pole piece (23) that has such a tight tolerance that the magnetic piston (19) is not brought into contact with the hollow cylinder when the width of the parasitic air gap (30) is less than 0.1 mm.

3. The electromagnet according to claim 2, characterized in that a second pole piece (23), which is designed as the identical part of the first pole piece (23), is disposed on the region opposite the aperture opening (25); and said second pole piece forms with its bushing part (29) the tight fit for the pole core (17) mounted in the hollow cylinder.

4. The electromagnet according to claim 1, characterized in that a magnetic return casing (13) that at least partially surrounds the winding (11) forms a magnetic return path to the flange part (27) of the pertinent pole piece (23).

5. The electromagnet according to claim 4, characterized in that in order to form a tight unit, the coil form (7), the pole piece (23), and the return casing (13) are encapsulated by injection molding with a plastic encapsulating compound (5) that forms a uniform housing (1).

6. The electromagnet according to claim 1, characterized in that the actuating plunger (21) of the magnetic piston (19) is mounted on the pole core (17) over a guideway (31) that forms, as the guide sleeve (21), a component of the sliding fit.
